(19) United States
(12) Patent Application Publication
(10) Pub. No.: US 2026/0360638 A1
(43) Pub. Date: Nov. 12, 2026

(54) SPHERICAL ROLLOVER SWITCH UNIT

(71) Applicant: LS AUTOMOTIVE TECHNOLOGIES CO., LTD., Anyang-si, Gyeonggi-do (KR)

(72) Inventor: Su Young AHN, Yongin-si, Gyeonggi-do (KR)

(73) Assignee: LS AUTOMOTIVE TECHNOLOGIES CO., LTD., Anyang-si, Gyeonggi-do (KR)

(21) Appl. No.: 19/126,143

(22) PCT Filed: Oct. 30, 2023
(86) PCT No.: PCT/KR2023/017029

§ 371 Date: Apr. 30, 2025

(30) Foreign Application Priority Data
Oct. 31, 2022 (KR) 10-2022-0143144

(51) Int. Cl. H01H 15/10; B60K 35/10; B62D 1/04; H01H 9/02

(52) U.S. Cl. CPC H01H 15/10; H01H 9/02; B60K 35/10; B60K 2360/131; B62D 1/046

(57) ABSTRACT

Provided is a sphere rollover switch device (10) including: a device housing (100); a sphere rollover unit (200) including a rollover unit housing (210) rotatably connected to the device housing (100) by means of a rotary shaft to perform an up-and-down reverse rotation, the sphere rollover unit being configured to perform a switching operation; and a sphere rollover driving unit (300) disposed in the device housing (100), and configured to provide a driving force for enabling the up-and-down reverse rotation, wherein the sphere rollover unit (200) incudes a rollover detection part (250) configured such that at least a part thereof is disposed at the rollover unit housing (210) and the remaining part thereof is disposed at the device housing (100). The rollover detection part (250) may be at least partially disposed on a rotary shaft for the up-and-down reverse rotation of the rollover unit housing (210).

### TECHNICAL FIELD

The present invention relates to a switch that is installed in vehicles. More specifically, the present invention relates to a switch device for vehicles, which is configured to implement a selection operation and/or combined operation and to achieve position switching through up-and-down reverse rotation while retaining a simple and compact structure.

### BACKGROUND ART

In general, a steering wheel assembly for vehicles includes a steering wheel, a steering column, a steering roll connector assembly, a multi-function switch assembly, and the like. The steering wheel is intended to allow a driver to determine the steering direction. The driver's rotation of the steering wheel is transferred to the vehicle wheels through the steering column so as to set the steering angle of the vehicle. In addition, vehicles such as automobiles are required to function not only as a means of transportation but also as various convenience means capable of providing users with a more stable and comfortable driving state.

For example, the steering wheel of a recently produced vehicle includes a window switch for opening and closing a window, a steering light switch for turning a steering light on or off, an audio switch for operating an audio device, and a wiper switch for driving wipers. The multi-function switch assembly includes switches for lights, fog lamps, wipers, various audio devices, and vehicle windows, and serves to enhance the operability of the various devices, thereby allowing the driver to maintain forward while operating such devices. The multi-functional switch assembly may be implemented as a button switch mounted on the upper portion of the steering wheel, as a vehicular lever switch on the side of the steering wheel, or as a console switch in which various functions are concentrated.

Recently, vehicle switches have shown a tendency toward the integrated combination of multi-function switches. As the functions of the switches increase, their structures become more complicated, thereby increasing the possibility of malfunction.

In particular, in the case of automotive switches that require emotion-based operation, there is an increasing demand for responsiveness to a variety of operational changes, as well as a growing expectation for emotional quality in switch devices with enhanced operability. To meet these demands, there is a growing need for various design approaches and corresponding switch structures.

### DISCLOSURE OF INVENTION

### Technical Problem

Accordingly, the present invention has been made to solve the above-mentioned problems occurring in the prior art, and it is an object of the present invention to provide a switch device that enables the implementation of a combined operation through a compact and simple structure, thereby improving durability, ensuring more accurate operation, and eliminating or minimizing play to prevent vibration and/or noise, and that also improves product quality by protecting the switch device or enhancing its external appearance through structural changes before and after a switching operation caused by the rollover movement.

### Technical Solution

To achieve the above object, the present invention provides a sphere rollover switch device (10) including: a device housing (100); a sphere rollover unit (200) comprising a rollover unit housing (210) rotatably connected to the device housing (100) by means of a rotary shaft so as to perform an up-and-down reverse rotation, the sphere rollover unit being configured to perform a switching operation; and a sphere rollover driving unit (300) disposed in the device housing (100), and configured to provide a driving force for enabling the up-and-down reverse rotation of the sphere rollover unit (200), wherein the sphere rollover unit (200) comprises a rollover detection part (250) configured such that at least a part thereof is disposed at the rollover unit housing (210) and the remaining part thereof is disposed at the device housing (100).

In the sphere rollover switch device, the rollover detection part (250) may be at least partially disposed on a rotary shaft for the up-and-down reverse rotation of the rollover unit housing (210), wherein the rollover detection part (250) may include a rollover detection sensor (251) and a rollover detection sensor counterpart part (253), and wherein the rollover detection sensor counterpart part (253) may be disposed on the rotary shaft of the rollover unit housing (210) so as to be fixed in position to the device housing (100).

In the sphere rollover switch device, the device housing may include a housing body (120) configured to support the rotation of the rollover unit housing (210), wherein the housing body (120) may include: a housing bottom body (121) mounted so as to be securely fixed in position; and a housing support body (123) formed extending upwardly from one surface of the housing bottom body (121), and wherein the rollover detection sensor counterpart part (253) may be disposed at the housing support body (123).

In the sphere rollover switch device, the housing support body (123) may include: a housing vertical support body (1231) connected at one end to the housing bottom body (121); and a housing vertical side body (1232) connected at one end to a side end of the housing vertical support body (1231) to allow the rollover unit housing (210) to be rotatably mounted, and wherein the rollover unit housing (210) may include: a rollover unit body (2110) disposed at both ends at the housing support body (123) in a relatively movable manner; and a rollover unit bearing (2130) disposed between the rollover unit body (2110) and the housing support body (123).

In the sphere rollover switch device, the housing vertical side body (1232) may include a side support hinge (12321) on at least one side thereof, the side support hinge (12321) being connected to the rollover unit housing (210) so as to be relatively rotatable with respect to the rollover unit housing (210), wherein the side support hinge (12321) may include a side support hinge extension part (12323) disposed to extend toward the rollover unit housing (210), and wherein the rollover detection sensor counterpart part (253) may be disposed at the side support hinge extension part (12323).

In the sphere rollover switch device, the rollover unit body (2110) may include: a rollover unit main body (21110) configured to be reversibly rotated up and down; and a pair of opposed rollover unit shaft bodies (21120; 21120a and 21120b) disposed at one ends on both sides of the rollover unit main body (21110) and connected at the other ends to the housing vertical side body (1232) and the housing vertical support body (1231) in a relatively rotatable manner.

In the sphere rollover switch device, a rollover unit shaft body extension receiving part (21121a) may be formed in any one of the rollover unit shaft bodies (21120a and 21120b), and wherein the side support hinge extension part (12323) may be receivingly disposed in the rollover unit shaft body extension receiving part (21121a).

In the sphere rollover switch device, the rollover detection sensor (251) may be disposed to confront the rollover detection sensor counterpart part (253).

In the sphere rollover switch device, wherein the rollover detection sensor (251) may be disposed to be spaced apart from the rotary shaft for the up-and-down reverse rotation of the rollover unit housing (210).

In the sphere rollover switch device, a shaft body driving counterpart part (21121b) may be disposed at any one of the rollover unit shaft bodies (21120a and 21120b), and wherein the sphere rollover driving unit (300) may be at least partially disposed at the shaft body driving counterpart part (21121b) to allow the shaft body driving counterpart part (21121b) to be applied with the driving force from a rollover driving actuator (330) of the sphere rollover driving unit (300).

In the sphere rollover switch device, the rollover unit bearing (2130) may be disposed between each of the rollover unit shaft bodies (21120a and 21120b) and the associated side support hinge (12321) on either side.

In the sphere rollover switch device, the sphere rollover unit (200) may include a rollover unit rotary switch part (230) configured to perform a rotary operation about an axis oriented to be orthogonal to the rotary shaft of the sphere rollover unit (200).

In the sphere rollover switch device, the rollover unit rotary switch part (230) may include: a rotary switch knob (2360) disposed on an upper portion of one surface of the rollover unit housing (210); a rotary switch rotor (2310) disposed in the rollover unit housing (210) to perform the rotary operation and is connected to an at least part of the rotary Switch knob (2360) ; and a rotary switch (2340) configured to generate a change in an electrical signal through the rotary operation of the rotary switch rotor (2310).

In the sphere rollover switch device, the rollover unit rotary switch part (230) may include a rotary switch rotor transfer part (2350) disposed between the switch rotor (2310) and the rotary switch (2340), wherein the rotary switch rotor transfer part (2350) may include; a rotor transfer driving part (2351) formed on a side of the outer circumferential surface of the rotary switch rotor (2310); and a rotor transfer driven part (2353) configured to allow the rotary switch (2340) to be at least partially disposed thereon and meshingly engaged with the rotor transfer driving part (2351).

In the sphere rollover switch device, the rollover unit rotary switch part (230) may further include a rotary switch detent part (2330) configured to perform a detenting operation during the rotation of the rotary switch rotor (2310).

In the sphere rollover switch device, the rollover unit rotary switch part (230) may further include a rotary switch self-return part (2320) configured to return the rotary switch rotor (2310) to a predetermined position when an external force applied thereto is removed.

In the sphere rollover switch device, the rotary switch self-return part (2320) may include a self-return roller (2321) disposed on the outer circumference of the rotary switch rotor (2310), and a self-return wedge guide (2323) including a predetermined profile and disposed on one surface of the rollover unit housing (210), the self-return wedge guide configured to be in a state of being in constant contact with the self-return roller (2321).

In the sphere rollover switch device, the rotary switch self-return part (2320) may further include a self-return roller stopper (2325) disposed at the outer side of the self-return wedge guide (2323) and configured to inhibit the operation of the self-return roller (2321).

In the sphere rollover switch device, the sphere rollover unit (200) may include a rollover unit push switch part (240) including a push switch (2440) configured to be operable by a pressing operation directed toward the rotary shaft of the rollover unit housing (210).

In the sphere rollover switch device, the rollover unit push switch part (240) may include: a push switch knob (2410) disposed to be pressable by a user; a push switch shaft (2420) connected at one end to the push switch knob (2410); and a push switch plunger (2430 disposed such that one end thereof is contactable with the push switch shaft (2420) and the other end thereof is positioned on the push switch (2440) so as to depress the push switch (2440).

In the sphere rollover switch device, the push switch shaft 2420 may include: a push switch shaft body (2421) disposed such that one end thereof is oriented toward the outside and the other end thereof is oriented toward the rotary shaft of the sphere rollover unit (200): and a push switch shaft base (2423) disposed at an end of the push switch shaft body (2421) and configured to be in contact with the push switch plunger (243)

In the sphere rollover switch device, the push switch plunger (2430) may include: a plunger body (2431) configured to be in contact with the push switch shaft base (2423) ; and a plunger stopper (2433) formed to extend downwardly from the plunger body (2431) toward the push switch (2440) so as to restrict the movement distance of the plunger body (2431).

In the sphere rollover switch device, the push switch (2440) may be provided in plural numbers so as to be arranged at equal angular intervals on a plane perpendicular to the moving direction of the push switch shaft (2420).

In the sphere rollover switch device, the rollover unit push switch part (240) may further include a push switch light source part (2460) configured to generate light to allow the light to be output toward the push switch knob (2410).

In the sphere rollover switch device, the sphere rollover unit (200) may include a rollover unit substrate (220) disposed at least partially within the rollover unit housing (210), and wherein the push switch light source part (2460) may include a push switch light source (2461) disposed on one surface of the rollover unit substrate (220): and a push switch light source transfer part (2463) disposed such that one end thereof confronts the push switch light source (2461) and the other end thereof is oriented toward the push switch knob (2410), and configured to transfer light emitted from the push switch light source (2461) to the push switch knob (2410).

In the sphere rollover switch device, the push switch knob (2410) may include: a knob inner body (2411) configured to accommodate at least part of the push switch light source transfer part (2463); and a knob outer body (2413) formed at least partially on the outer circumference of the knob inner body (2411), with one surface thereof exposed to the outside.

In the sphere rollover switch device, the knob inner body (2411) may be at least partially disposed to be exposed at both sides to the outside, and may externally expose light transferred thereto through the push switch light source transfer part (2463).

In the sphere rollover switch device, the knob outer body (2413) may expose, to the outside, light transferred through the push switch light source transfer part (2463).

In the sphere rollover switch device, the sphere rollover driving unit (300) may include: a rollover driving housing (310) disposed to be fixed in position to the device housing (100); a rollover driving actuator (330) disposed within the rollover driving housing (310); and a rollover driving transfer gear part (320) meshingly engaged at one end with the rollover driving actuator (330) and at the other end with the rollover unit housing (210) to allow a driving force generated from the rollover driving actuator (330) to be transferred to the rollover unit housing (210).

In the sphere rollover switch device, the sphere rollover switch device (10) may further including a device substrate (400) disposed within the device housing (100), wherein the sphere rollover unit (200) comprises a rollover unit substrate (220), and wherein the rollover unit substrate (220) may include: a rollover unit inner substrate (2210) disposed within the rollover unit housing (210); and a rollover unit connection substrate (2220) connected at one end to the rollover unit inner substrate (2210) and at the other end to the device substrate (400).

In the sphere rollover switch device, the rollover unit substrate (220) may be drawn out from the rollover unit housing (210) in a direction of an imaginary line drawn perpendicularly from the central point of the rotary shaft of the rollover unit housing (210).

In the sphere rollover switch device, the housing body (120) of the device housing (100) may include a housing body flip space (126) formed therein, and wherein the up-and-down reverse rotation of the rollover unit body (2110) may enable the rollover unit connection substrate (2220) to be flipped within the housing body flip space (126).

In the sphere rollover switch device, the housing body flip space (126) may be defined by a housing body convex part (1261) and a housing body concave part 1263 of the housing body (120), wherein the housing body convex part (1261) may be formed to be at least partially protruded toward the housing body flip space (126) of the housing body (120) from the outer surface thereof, and wherein when viewed from a plane perpendicular the rotary shaft of the sphere rollover unit (200), a position, which has a maximum value of a profile radius from the center of the rotary shaft of the sphere rollover unit (200) to the inner surface of the housing body that defines the housing body flip space (126), may be formed on the housing body concave part (1263).

In the sphere rollover switch device, when one surface of interest of the sphere rollover unit (200) is disposed to be exposed to the outside, and a point at which the rollover unit connection substrate (2220) is drawn out from the sphere rollover unit (200) is positioned adjacent to the housing body convex part (1261), the rollover unit connection substrate (2220) may include two flip regions (Wf1, Wf2).

In the sphere rollover switch device, when one surface of interest of the sphere rollover unit (200) is disposed to be oriented toward the inside of the housing body (120), and a point at which the rollover unit connection substrate (2220) is drawn out from the sphere rollover unit (200) is positioned adjacent to the housing body concave part (1263), the rollover unit connection substrate (2220) may include one flip region (Wf3).

In the sphere rollover switch device, the rollover unit connection substrate (2220) may be electrically connected to a surface of the device substrate (400) opposite to the surface thereof that confronts the sphere rollover unit (200).

In the sphere rollover switch device, the device substrate (400) may include a substrate through-opening (401) formed therein, wherein the housing body (120) may include a housing body extension part (128) formed at a lower end thereof, wherein the housing body extension part (128) may include a housing body extension through-opening (129) formed therein, wherein the housing body extension part (128) may be disposed to pass through the substrate through-opening (401), and wherein the rollover unit connection substrate (2220) may be disposed to pass through the housing body extension through-opening (129).

In the sphere rollover switch device, the rollover unit body (2110) of the rollover unit housing (210) may include a rollover unit outer body (21140) disposed at the outer side thereof, and wherein the rollover unit outer body (21140) may include an outer body connection withdrawal opening (21145) formed on the outer circumferential edge thereof to allow the rollover unit connection substrate (2220) to be withdrawn therethrough.

In the sphere rollover switch device, the rollover unit outer body (21140) may include an outer body chamfering connection guide (21147) formed on the outer periphery of the outer body connection withdrawal opening (21145) thereof, and wherein the outer body chamfering connection guide (21147) may guide the rollover unit connection substrate (2220) during the up-and-down reverse rotation of the rollover unit body (2110).

In the sphere rollover switch device, the device housing (100) may include a housing connection guide (127) formed therein so as to be contactable with the rollover unit connection substrate (2220) upon the up-and-down reverse rotation of the rollover unit body (2210).

### Advantageous Effects

According to the present invention, the sphere rollover switch device is mounted on a steering wheel or a console switch device in the interior of a vehicle to enable the implementation of a combined operation for selecting or adjusting electrical functions of a vehicle shift range switching device, navigation device, an audio multimedia device, an air conditioning device, or the like, which are built into vehicles.

In addition, the up-and-down reverse rotation operation of the sphere rollover switch device according to the present invention can be detected more rapidly and accurately through a simplified structure.

Further, an interference of the constituent elements, particularly a noise that may be caused by the rollover unit connection substrate, can be minimized during the up-and-down reverse rotation operation of the sphere rollover switch device of the present invention. In addition, a stable unwinding operation of the rollover unit connection substrate can be achieved, thereby preventing bending or twisting of the substrate.

In addition, the lateral arrangement of the sphere rollover driving unit of the sphere rollover switch device according to the present invention can enhance maintainability and assemblability through modularization.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic perspective view illustrating a sphere rollover switch device according to an embodiment of the present invention.

FIGS. 2 and 3 are schematic partial perspective views illustrating a sphere rollover switch device before and after an up-and-down reverse rotation according to an embodiment of the present invention.

FIG. 4 is a schematic partial exploded perspective view illustrating a sphere rollover switch device according to an embodiment of the present invention.

FIG. 5 is a schematic partial exploded perspective view illustrating a rotary switch knob of a sphere rollover switch device according to an embodiment of the present invention.

FIG. 6 is a schematic partial exploded perspective view illustrating a housing body and the like of a sphere rollover switch device according to an embodiment of the present invention.

FIG. 7 is a schematic partial exploded perspective view illustrating a sphere rollover unit of a sphere rollover switch device according to an embodiment of the present invention.

FIG. 8 is a schematic partial exploded perspective view illustrating a rollover unit rotary switch part of a sphere rollover switch device according to an embodiment of the present invention.

FIG. 9 is a schematic partial exploded perspective view illustrating a partial configuration of a rollover unit body and a rollover unit push switch part of a sphere rollover switch device according to an embodiment of the present invention.

FIG. 10 is a schematic partial cross-sectional view illustrating a sphere rollover unit of a sphere rollover switch device according to an embodiment of the present invention.

FIG. 11 is a schematic perspective view illustrating a rollover detection part of a sphere rollover switch device according to an embodiment of the present invention.

FIG. 12 is a schematic partial cross-sectional view illustrating a push switch of a sphere rollover switch device according to an embodiment of the present invention.

FIG. 13 is a schematic exploded perspective view illustrating a sphere rollover driving unit of a sphere rollover switch device according to an embodiment of the present invention.

FIG. 14 is a schematic cross-sectional view illustrating a sphere rollover driving unit of a sphere rollover switch device according to an embodiment of the present invention.

FIG. 15 is a schematic partial perspective view illustrating a connection and assembly process of a rollover unit connection substrate of a sphere rollover switch device according to an embodiment of the present invention.

FIG. 16 is a schematic front view illustrating the exposed state of a rollover unit rotary switch part and a rollover unit push switch part a sphere rollover switch device according to an embodiment of the present invention.

FIGS. 17 to 19 are schematic side cross-sectional views illustrating an up-and-down reverse rotation process of a sphere rollover unit of a sphere rollover switch device according to an embodiment of the present invention.

FIG. 20 is a schematic side cross-sectional view illustrating a modification of a guide structure for a rollover unit connection substrate of a sphere rollover switch device according to an embodiment of the present invention.

FIG. 21 is a schematic partial horizontal cross-sectional view illustrating a rotary switch detent part of a sphere rollover switch device according to an embodiment of the present invention.

### BEST MODE FOR CARRYING OUT THE INVENTION

Now, the preferred embodiments of the present invention will be described hereinafter in detail with reference to the accompanying drawings. It should be noted that the same elements in the drawings are denoted by the same reference numerals although shown in different figures. In the following description, the detailed description on known function and constructions unnecessarily obscuring the subject matter of the present invention will be avoided hereinafter.

A sphere rollover switch device 10 according to an embodiment of the present invention includes a device housing 100, a sphere rollover unit 200, and a sphere rollover driving unit 300, and a device substrate 400 is disposed within the device housing 100.

The sphere rollover unit 200 is disposed within the device housing 100, and includes a rollover unit housing 210. The rollover unit housing 210 is connected to the device housing 100 through a rotary shaft so as to enable an up-and-down reverse rotation. The sphere rollover unit 200 is configured to perform a switching operation. The sphere rollover driving unit 300 is disposed in the device housing 100, and provide a driving force for enabling the up-and-down reverse rotation of the sphere rollover unit 200. The sphere rollover unit 200 includes a rollover detection part 250 configured such that at least a part thereof is disposed on the rotary shaft for the up-and-down reverse rotation of the rollover unit housing 210.

More specifically, the device housing is securely fixed to a vehicle to enable a stable operation of the sphere rollover unit 200 which will be described later. The device housing 100 includes a housing cover 110, a housing body 120, and a housing base 130. In this embodiment, the housing cover 110 and the housing base 130 are engaged with each other to have an internal space defined therebetween.

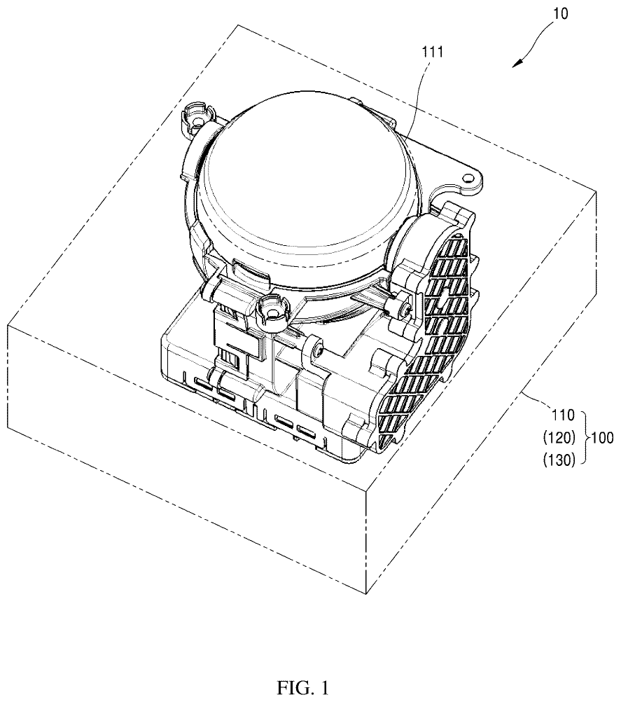

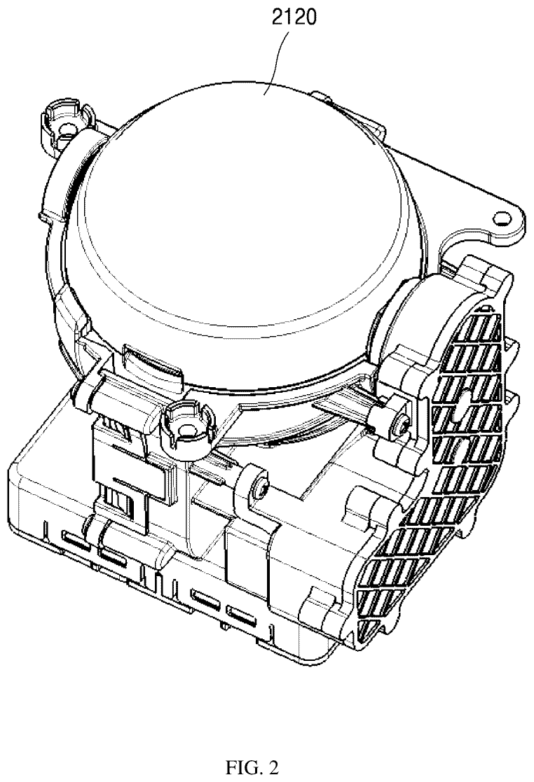

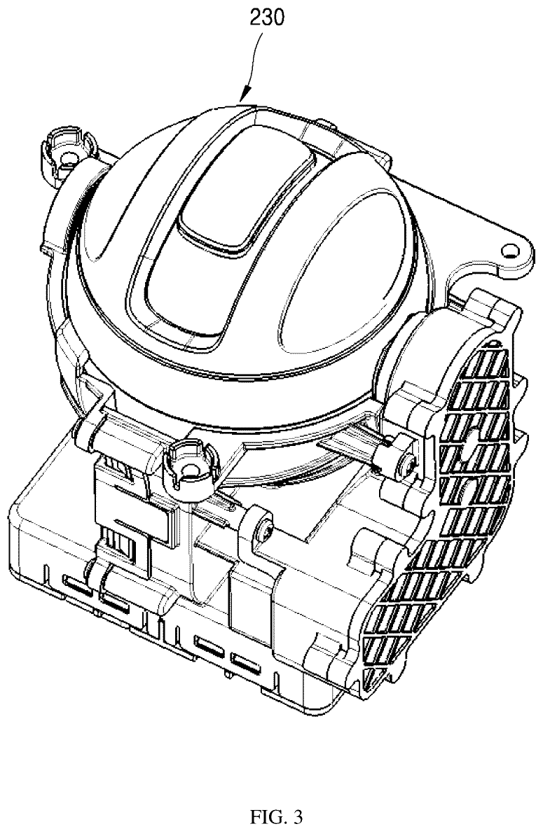

As shown in FIG. 1, the housing cover 110 includes a housing cover through-opening 111 formed on one surface thereof. The sphere rollover unit 200, which will be described later, may be partially exposed to the outside through the housing cover through-opening 111.

The housing body 120 is disposed in the internal space formed between the housing cover 110 and the housing base 130. The housing body 120 includes a housing bottom body 121, a housing support body 123, and a housing lower body 125.

The housing bottom body 121 and the housing lower body 125 are engaged with each other to define an internal space therebetween, and the device substrate 400 is disposed in the internal space.

The housing support body 123 is formed extending upwardly from one surface of the housing bottom body 121. The housing support body 123 and the housing bottom body 121 may be configured separately from each other, but will be described focusing on a configuration of being formed integrally with each other in this embodiment. The housing support body 123 is configured to support the rotation operation of the sphere rollover unit 200. Specifically, the housing support body 123 is configured to rotatably support the rollover unit housing 210 of the sphere rollover unit 200.

The housing support body 123 includes a housing vertical support body 1231 and a housing vertical side body 1232.

The housing vertical support body 1231 is connected at one end to the housing bottom body 121, and the other end thereof is formed as a free end. The rollover unit housing 210 is configured to be hingedly connected to the other end of the housing vertical support body 1231 so as to be relatively rotatable with respect to the housing vertical support body 1231. In this embodiment, the housing vertical support body 1231 includes a concaved structure for supporting the rollover unit housing 210 in a relatively rotatable manner, but various modifications may be made thereto.

The housing vertical side body 1232 enables the rollover unit housing 210 to be rotatably mounted. The housing vertical side body 1232 is connected at one end to a side end of the housing vertical support body 1231. The rollover unit housing 210 is mounted and supported stably in a relatively rotatable manner by the housing vertical side body 1232 and the housing vertical support body 1231.

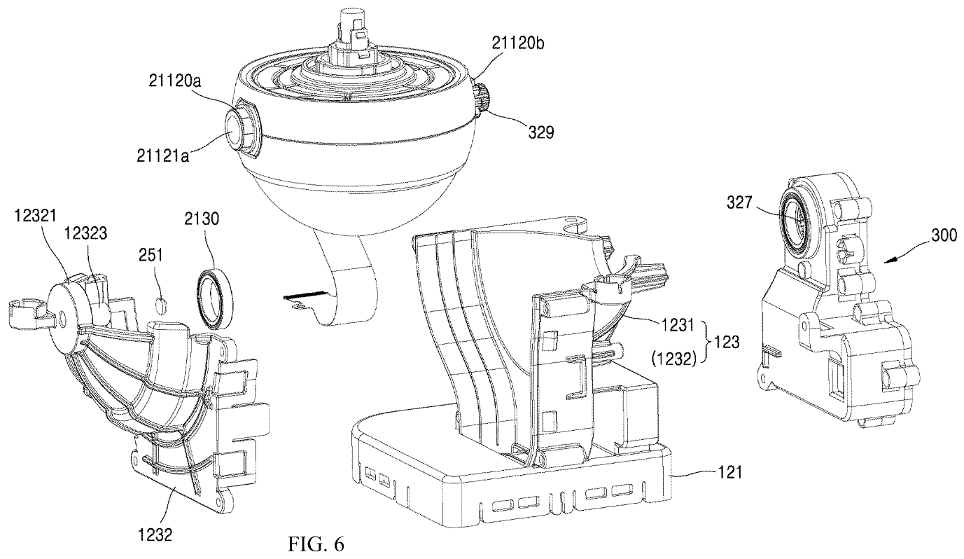

As shown in FIG. 6, the housing vertical side body 1232 includes a side support hinge 12321 on at least one side thereof. The side support hinge 12321 is connected to the rollover unit housing 210 so as to be relatively rotatable with respect to the rollover unit housing 210.

The side support hinge 12321 includes a side support hinge extension part 12323. The side support hinge extension part 12323 is disposed to extend toward the rollover unit housing 210. The side support hinge extension part 12323 is disposed on the rotary shaft for the up-and-down reverse rotation of the sphere rollover unit 200. In an embodiment of the present invention, the rollover detection part 250, which will be described later, is at least partially disposed at the side support hinge extension part 12323.

The sphere rollover unit 200 includes the rollover unit housing 210 that is connected to the device housing 100 through a rotary shaft so as to enable an up-and-down reverse rotation. The sphere rollover unit 200 may perform a switching operation.

The rollover unit housing 210 includes a rollover unit body 2110 and a rollover unit 2130. In this embodiment, the rollover unit housing 210 further includes a rollover unit hemisphere 2120. The rollover unit hemisphere 2120 is disposed on one surface of the rollover unit body 2110 so that the rollover unit body 2110 can be exposed to the outside along with the up-and-down reverse rotation of the rollover unit housing 210. The rollover unit hemisphere 2120 includes a rollover unit hemisphere frame 2123 and a rollover unit hemisphere body 2121. The rollover unit hemisphere frame 2123 may be configured to engage with a rollover unit main body 21110, which will be described later, so as to define a space therebetween.

The rollover unit hemisphere body 2121 of the rollover unit hemisphere 2120 may be implemented as a lighting element, and may also be implemented in various other forms depending on design specifications, such as a structure different from a switch structure, which will be described later.

The rollover unit body 2110 is disposed at both ends at the housing support body 123 in a relatively movable manner, and the rollover unit bearing 2130 is disposed between the rollover unit body 2110 and the housing support body 123 so as to ensure a smooth relative rotation therebetween In this embodiment, the rollover unit bearing 2130 is disposed at both ends of the rotary shaft of the rollover unit body 2110 to form a stable support structure and a relative rotation structure without being twisted to either side.

The rollover unit body 2110 includes a rollover unit main body 21110 and a rollover unit shaft body 21120 (21120a and 21120b).

The rollover unit main body 21110 is rotatably disposed with respect to the device housing 100 so as to permit the up-and-down reverse rotation. Other constituent elements are disposed on the rollover unit main body 21110 to perform a predetermined switching operation. The rollover unit main body 21110 has a through-opening 21111 formed at the center thereof so that a rollover unit push switch part 240, which will be described later, is partially disposed to pass through the through-opening. A rollover unit main body rotary through-opening 21113 is formed at the outer side of the through-opening 21111 of the rollover unit main body 21110 so that a constituent element of the rollover unit rotary switch part 230 is rotatably seated in the rotary through-opening.

A connection substrate withdrawal part 21115 is disposed on an outer circumference of the rollover unit main body 21110. The withdrawal part 21115 is formed at a point on the outer circumference of the rollover unit main body 21110, which is orthogonally offset from an imaginary line drawn perpendicularly from the central point of the rotary shaft of the rollover unit main body 21110.

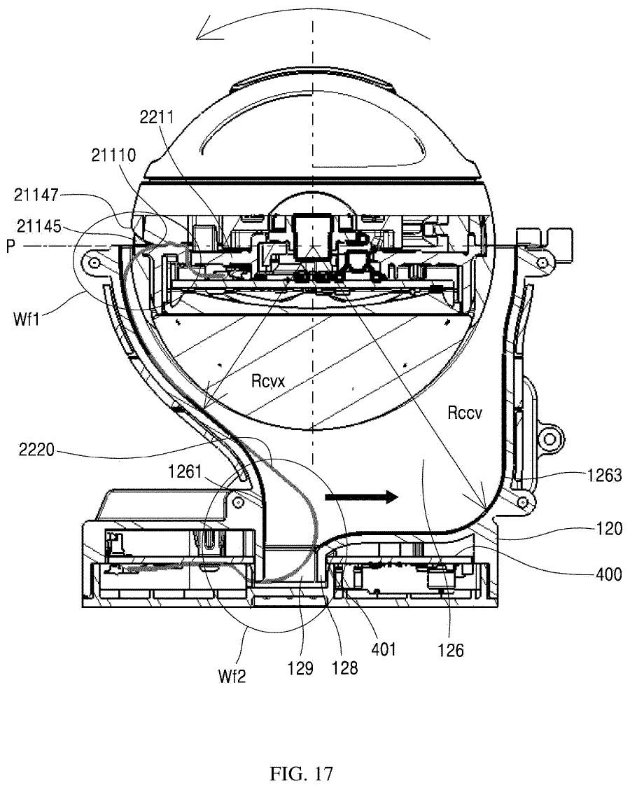

In other words, the connection substrate withdrawal part 21115 is located at the point on the outer circumference that lies farthest from the rotary shaft during the rotation of the rollover unit main body 21110. As shown in FIGS. 17 to 19,

The twisting of the rollover unit connection substrate 2220, which will be described later, may be prevented or minimized by the connection substrate withdrawal parts 21115 formed at two symmetrical points on the outer circumference of the rollover unit main body 21110 as the position line moves from P to R via S during the up-and-down reverse rotation of the rollover unit main body 21110.

The rollover unit shaft bodies 21120a and 21120b are disposed on the rollover unit main body 21110. More specifically, rollover unit shaft bodies 21120a and 21120b are positioned at one ends on both sides of the rollover unit main body 21110 and are disposed to be supported at the other ends by the housing support body 123.

That is, the rollover unit shaft bodies 21120a and 21120b are respectively disposed on both sides of the rollover unit main body 21110 so as to be relatively rotatably connected to the housing vertical side body 1232 and the housing vertical support body 1231.

In addition, a rollover unit shaft body extension receiving part 21121a is formed in any one of the rollover unit shaft bodies 21120a and 21120b of the present invention. As shown in FIG. 6, in this embodiment, the rollover unit shaft body extension receiving part 21121a is formed in the rollover unit shaft body indicated by reference numeral 21120a.

The rollover unit shaft body 21120a is positioned to confront the housing vertical side body 1232 disposed on the left side of the drawing sheet of FIG. 6. The side support hinge extension part 12323 disposed on the housing vertical side body 1232 is receivingly disposed in the rollover unit shaft body extension receiving part 21121a.

In addition, a shaft body driving counterpart part 21121b is formed in any one of the rollover unit shaft bodies 21120a and 21120b of the present invention. As shown in FIG. 6, in this embodiment, the shaft body driving counterpart part 21121b is formed in the rollover unit shaft body indicated by reference numeral 21120b. In this embodiment, the rollover unit shaft body 21120b is engaged with the sphere rollover driving unit 300, which will be described later, so as to receive a force for the up-and-down reverse rotation from the sphere rollover driving unit 300.

The rollover unit bearing 2130 described above is disposed between each of the rollover unit shaft bodies 21120a and 21120b and the associated side support hinge 12321 on either side to form a stable rotation structure. Such a rotation support structure on both sides can prevent twisting malfunction of the rollover unit body 2110 due to eccentricity during its up-and-down reverse rotation.

The rollover unit body 2110 of the rollover unit housing 210 further includes a rollover unit inner body 21130 and a rollover unit outer body 21140.

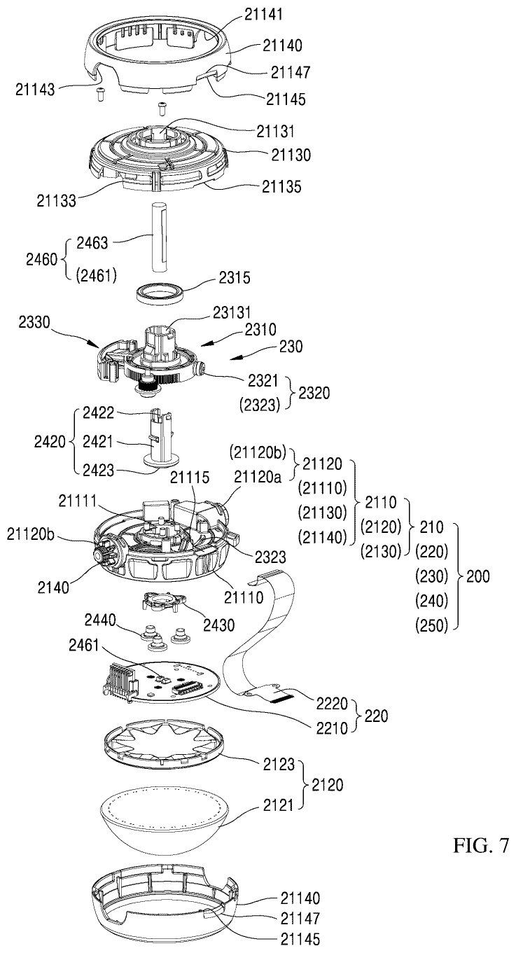

Referring to FIG. 7, the rollover unit inner body 21130 is disposed on the upper end of the rollover unit main body 21110. The rollover unit inner body 21130 includes a through-opening 21131 formed at the center thereof so that a part of the rollover unit push switch part 240 can be penetratingly disposed through the through-opening.

The rollover unit inner body 21130 includes an inner body hinge receiving part 21133 formed on the outer circumferential edge thereof so that the rollover unit shaft body 21120 is receivingly disposed in the inner body hinge receiving part 21133, thereby preventing interference between elements.

The rollover unit inner body 21130 includes a connection withdrawal opening 21135 formed on the outer circumferential edge thereof. The rollover unit connection substrate 2220 is withdrawn into or from the rollover unit body 2110 through the rollover unit inner body connection withdrawal opening 21135 so that an electrical signal can be transmitted to an external device through the switching elements and the unit substrate.

The rollover unit outer body 21140 includes a through-opening 21141 formed at the center thereof to allow other elements to be penetratingly disposed therethrough. Referring to FIG. 7, the rollover unit outer body 21140 is disposed with the rollover unit inner body 21130 interposed between the rollover unit outer body 21140 and the rollover unit main body 21110. The rollover unit outer body 21140 is engaged with the upper and lower ends of the rollover unit main body 21110 so as to accommodate the rollover unit main body 21110 therein.

The rollover unit outer body 21140 includes an outer body connection withdrawal opening 21145 formed on the outer circumferential edge thereof so that the rollover unit connection substrate 2220 can be withdrawn through the outer body connection withdrawal opening 21145. The rollover unit outer body 21140 includes an outer body chamfering connection guide 21147 formed on the outer periphery of the outer body connection withdrawal opening 21145 thereof.

The outer body chamfering connection guide 21147 guides the rollover unit connection substrate 2220 during the up-and-down reverse rotation of the rollover unit body 2110. In other words, the outer body chamfering connection guide 21147 is configured to form a predetermined angle so as to guide the rollover unit connection substrate 2220 drawn out from the outer body connection withdrawal opening 21145 during the up-and-down reverse rotation of the rollover unit body 2110.

Such a configuration may prevent the rollover unit connection substrate 2220 from being excessively bent during the up-and-down reverse rotation of the rollover unit body 2110.

The sphere rollover unit 200 according to an embodiment of the present inventio includes a rollover unit rotary switch part 230.

In other words, the sphere rollover unit 200 includes a rollover unit rotary switch part 230 that enables a rotary operation about an axis oriented to be orthogonal to the rotary shaft of the sphere rollover unit 200.

The rollover unit rotary switch part 230 includes a rotary switch knob 2360, a rotary switch rotor 2310, and a rotary switch 2340.

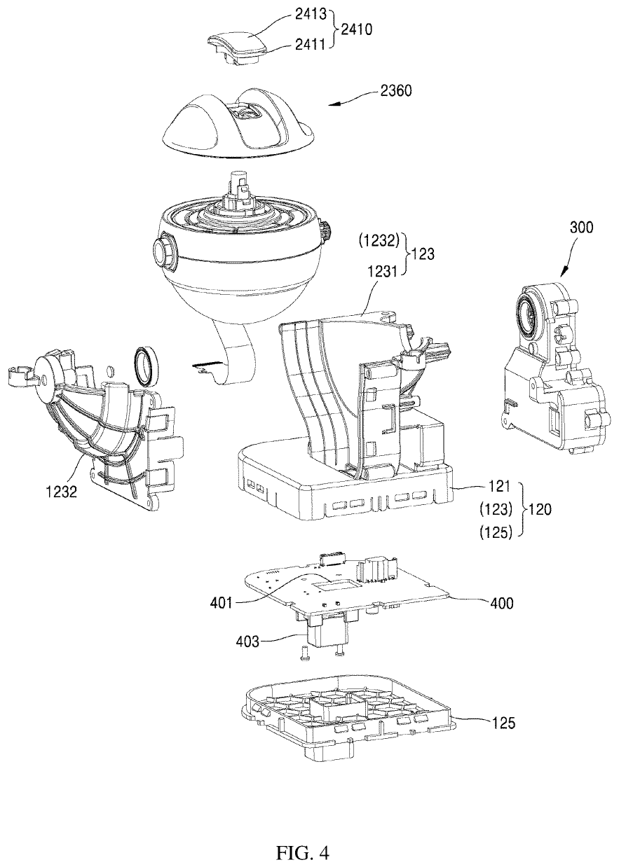

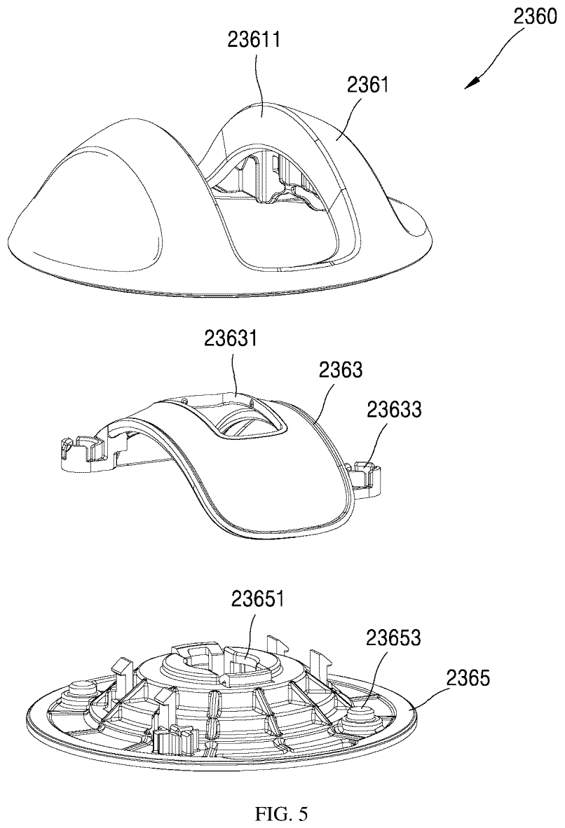

The rotary switch knob 2360 is disposed on an upper portion of one surface of the rollover unit housing 210. Referring to FIGS. 4 and 5, the rotary switch knob 2360 is disposed on the upper portion of the rollover unit inner body 21130 of the rollover unit body 2110 in a relatively rotatable manner. More specifically, the rotary switch knob 2360 includes a rotary switch outer knob 2361, a rotary switch medium knob 2363, and a rotary switch base knob 2365.

The rotary switch outer knob 2361 is disposed to be exposed to the outside. A predetermined groove and a curved portion are formed on the outer surface of the rotary switch outer knob 2361 to provide a user with increased gripability so that the user can implement a stable rotary switching operation. The rotary switch outer knob 2361 includes an outer knob through-opening 23611 formed to extend across the central portion thereof.

The rotary switch base knob 2365 is disposed on the upper portion of the rollover unit inner body 21130. The rotary switch base knob 2365 is disposed so as to be relatively movable with respect to the rollover unit inner body 21130. The rotary switch base knob 2365 also includes a base knob through-opening 23651 formed at the center thereof to allow other elements to be penetratingly disposed therethrough.

The rotary switch medium knob 2363 is disposed between the rotary switch outer knob 2361 and the rotary switch base knob 2365. The rotary switch medium knob 2363 also includes a medium knob through-opening 23631 formed at the center thereof.

The rotary switch medium knob 2363 includes a medium knob holder 23633 formed on the outer circumference thereof, and the rotary switch medium knob holder 23633 is engaged with a base knob holder 23653 formed on the outer circumference of the rotary switch base knob 236. Such an engagement structure restricts the relative rotation between the rotary switch medium knob 2363 and the rotary switch base knob 2365 and allows the relative rotation between the rotary switch medium knob 2363 and the rotary switch base knob 2365 to operate integrally with each other.

In the meantime, the rotary switch rotor 2310 of the rollover unit rotary switch part 230 is disposed in the rollover unit housing 210 to enable a rotary operation, and is connected to an at least part of the rotary switch knob 2360. A rotary switch base-housing engaging part is formed on the outer circumference of the base knob through-opening 23651 of the rotary switch base knob 2365 described above.

The rotary switch base-housing engaging part is fasteningly engaged with a rotor shaft engaging part formed on the upper end of a rotor shaft 2311 of the rotary switch rotor 2310, which will be described later.

More specifically, the rotary switch rotor 2310 includes a rotor body 2311 and a rotor shaft 2313. The rotary switch rotor 2310 is rotatably disposed on one surface of the rollover unit main body 21110 of the rollover unit body 2110. The rotor shaft 2313 is formed to extend upwardly from one surface of the rotor body 2311.

The rotor shaft 2313 includes a rotor shaft through-opening 23131 formed at the center thereof to allow other elements to be penetratingly disposed therethrough. The rotor shaft 2313 includes a rotor shaft bearing seating part 23133 formed on the outer circumference thereof to allow a rotor bearing 2315 (see FIG. 7) to be seatingly disposed thereon, thereby ensuring the smooth relative rotation between the rotary switch rotor 2310 and the rollover unit inner body 21130. The rotor shaft bearing seating part 23133 includes a bearing seating part stopper formed on the outer side thereof to prevent the escape of the rotor bearing 2315 from the rotor shaft bearing seating part 23133.

The rotary switch 2340 generates a change in an electrical signal through the rotary operation of the rotary switch rotor 2310. The rotary switch 2340 includes a rotary switch moving part 2341 and a rotary switch fixed part 2343. The rotary switch moving part 2341 is configured as a magnet, and the rotary switch fixed part 2343 is configured as a magnetic sensor.

The rotary switch fixed part 2343 is disposed on a rollover unit inner substrate 2210 disposed within the rollover unit body 2110. The rotary switch moving part 2341 and the rotary switch fixed part 2343 may be modified in various forms depending on design specifications within the scope of detecting the rotary operation.

The rollover unit rotary switch part 230 includes a rotary switch rotor transfer part 2350. The rotary switch rotor transfer part 2350 is disposed between the switch rotor 2310 and the rotary switch 2340. The rotary switch rotor transfer part 2350 includes a rotor transfer driving part 2351 and a rotor transfer driven part 2353.

The rotor transfer driving part 2351 is formed on a side of the rotary switch rotor 2310, and the rotor transfer driven part 2353 allows the rotary switch 2340 to be at least partially disposed thereon and meshingly engaged with the rotor transfer driving part 2351.

More specifically, the rotor transfer driving part 2351 is formed on the outer circumferential surface of the rotor body 2311 of the rotary switch rotor 2310, and the rotor transfer driven part 2353 is movably seated in the rollover unit main body rotary through-opening 21113 so as to be meshingly engaged with the rotor transfer driving part 2351. The rotary switch moving part 2341 of the rotary switch 2340 is disposed on the rotor transfer driven part 2353.

The rotary rotation force of the rotary switch knob 2360 and the rotary switch rotor 2310 allows the rotation state of the rotary switch 2340 to be detected through the rotary switch rotor transfer part 2350.

Meanwhile, the rollover unit rotary switch part 230 of the present invention may further include a constituent element configured to enhance tactile detection and, if necessary, provides a restoring force to return to the original position.

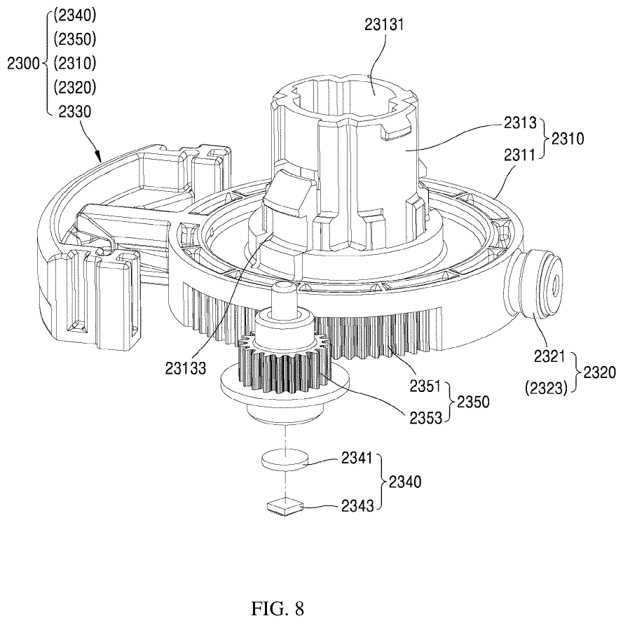

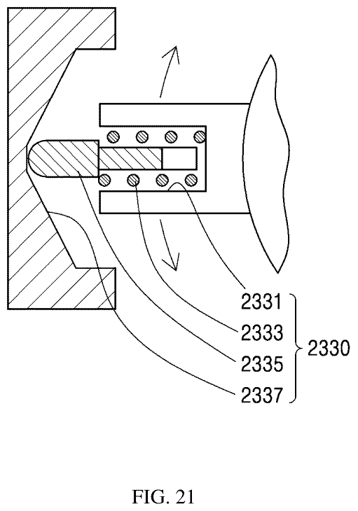

That is, as shown in FIGS. 8 and 21, the rollover unit rotary switch part 230 includes a rotary switch detent part 2330. The rotary switch detent part 2330 performs a detenting operation during the rotation of the rotary switch rotor 2310.

The rotary switch detent part 2330 includes a detent receiving part 2331, a detent elastic part 2333, a detent 2335, and a detent recess 2337.

The detent receiving part 2331 is disposed at the outer side of the rotor body 2311. The detent elastic part 2333 is received in the detent receiving part 2331. The detent 2334 is disposed at an end of the detent elastic part 2333, and is elastically supported by the detent elastic part 2333 to form a state of being in contact with the detent recess 2335. The detent recess 2337 includes a predetermined profile to allow a user to tactilely perceive the rotation state.

In the meantime, the rollover unit rotary switch part 230 may further include a rotary switch self-return part 2320. The rotary switch self-return part 2320 serves to return the rotary switch rotor 2310 to a predetermined position when an external force applied thereto is removed.

The rotary switch self-return part 320 includes a self-return roller 2321 and a self-return wedge guide 2323. The self-return roller 2321 is disposed on the outer circumference of the rotary switch rotor 2310. The self-return roller 2321 is rotatably disposed on the outer circumference of the rotary switch rotor 2310. In this embodiment, the self-return roller 232 is disposed on the side opposite to the rotary switch detent part 2330 described above, but the position and number of the self-return roller 232 may be selected in various manners within the scope of permitting a stable operation. In addition, in this embodiment, the self-return roller 2321 may be configured to rotate freely, but may be modified in various forms, such as a simple journal bearing structure of permitting its relative movement with respect to the self-return wedge guide 2323.

The self-return wedge guide 2323 includes a predetermined profile and is disposed on one surface of the rollover unit housing 210. In this embodiment, the self-return wedge guide 2323 includes a triangular wedge profile formed in the circumferential direction of the rotor body 2311. By virtue of such a structure, as the amount of rotation of the rotor body 2311 increases, a repulsive load increases due to the increasing inclination angle of the triangular wedge profile. This allows the user to perceive the amount or state of rotation through increased tactile feedback resulting from the repulsive force during rotational manipulation.

The self-return wedge guide 2323 is in a state of being in constant contact with the self-return roller 2321. Changing the predetermined profile of the self-return wedge guide 2323 allows for the provision of various tactile sensations during manipulation.

In addition, the rotary switch self-return part 2320 further includes a self-return roller stopper 2325. The self-return roller stopper 2325 is disposed at the outer side of the self-return wedge guide 2323 and inhibits the operation of the self-return roller 2321.

In this embodiment, the self-return roller stopper 2325 is configured to be disposed at both ends of the self-return wedge guide 2323 on the circumference of the rotor body 2311, but the number of the self-return roller stoppers may be determined in various manners depending on design specifications.

Further, the sphere rollover unit 200 includes the rollover unit push switch part 240. The rollover unit push switch part 240 includes a push switch 2440. The push switch 2440 is configured to be operable by a pressing operation directed toward the rotary shaft of the rollover unit housing 210.

The rollover unit push switch part 240 includes a push switch knob 2410, a push switch shaft 2420, and a push switch plunger 2430.

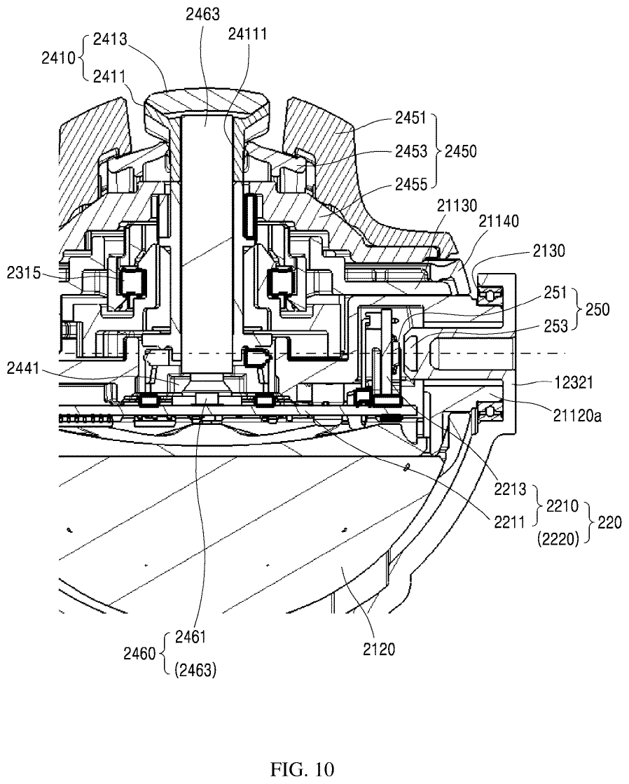

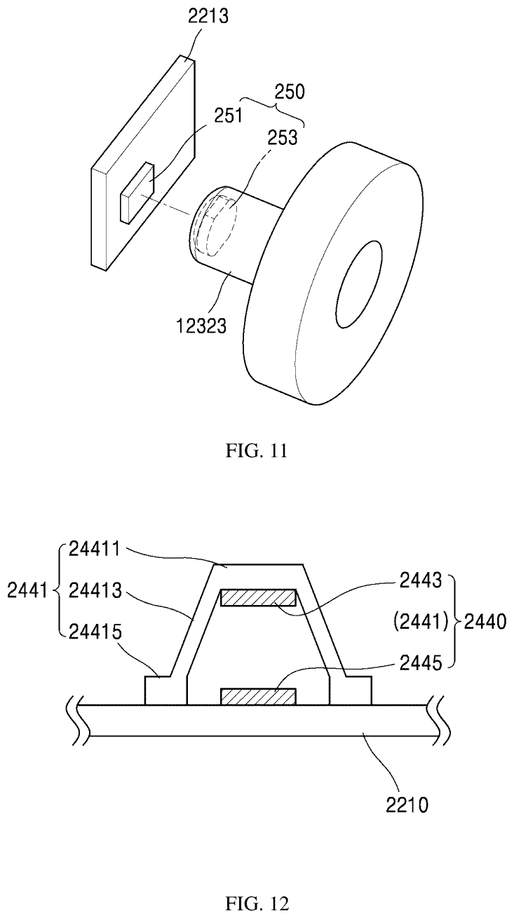

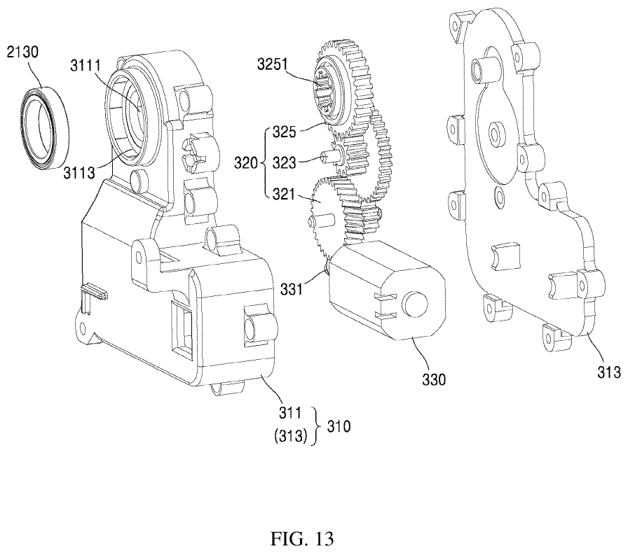

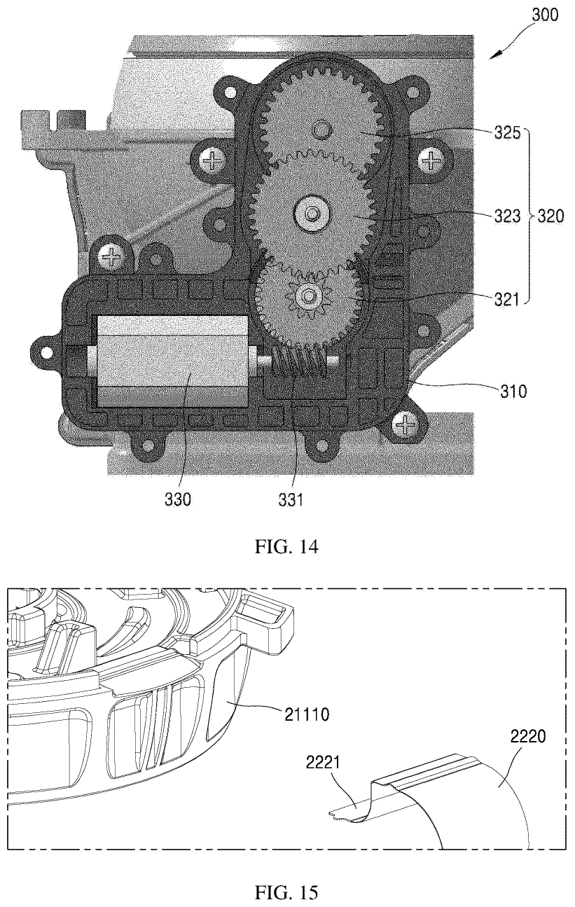

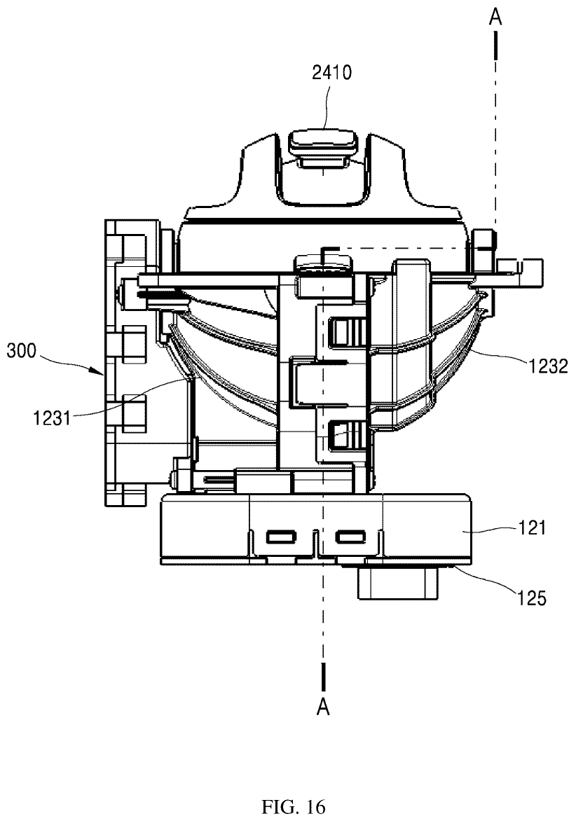

The push switch knob 2410 is disposed to be pressable by a user. As shown in FIGS. 4 and 10, the push switch knob 2410 includes a knob inner body 2411 and a knob outer body 2413. The knob inner body 2411 accommodates at least part of a push switch light source transfer part 2463, which will be described later.

The knob outer body 2413 is formed at least partially on the outer circumference of the knob inner body 2411, with one surface thereof exposed to the outside. When viewed from the cross-sectional view shown in FIG. 10, the knob outer body 2413 is configured to surround the knob inner body 2411, and the knob inner body 2411 is exposedly disposed on a side of the push switch knob 2410.

In this embodiment, the knob inner body 2411 is at least partially disposed to be exposed at both sides to the outside, and may expose, to the outside, light transferred thereto through the push switch light source transfer part 2463. In other words, the knob inner body 2411 may be made of a material that transmits light and the knob outer body 2413 may be made of a material that blocks light so that light generated from a push switch light source part 2460, which will be described later, is emitted only through the knob inner body 2411.

In addition, the knob outer body 2413 may be configured to expose, to the outside, light transferred through the push switch light source transfer part 2463, if necessary. In other words, the knob outer body 2413 may be made of a material that transmits light and the knob inner body 2411 may be made of a material that blocks light so that light generated from the push switch light source part 2460, which will be described later, is emitted only through the knob outer body 2413.

Further, if necessary, the knob inner body 2411 and the knob outer body 2413 may be modified in various manner forms, such as being formed of materials having different colors so as to emit light in different colors.

The push switch shaft 2420 is connected at one end to the push switch knob 2410. The push switch shaft 2420 includes a push switch shaft body 2421 and a push switch shaft base 2423.

The push switch shaft body 2421 is disposed such that one end thereof is oriented toward the outside and the other end is oriented toward the rotary shaft of the sphere rollover unit 200. The push switch shaft body 2421 has a through-opening 2422 formed at the center thereof. The through-opening 2422 may be formed such that at least part of light emitted from the push switch light source part 2460 is transferred to the top therethrough, or may be formed such that part of the push switch light source part 2460 is penetratingly disposed therein.

The push switch shaft base 2423 is disposed at an end of the push switch shaft body 2421 and is in contact with the push switch plunger 2430.

The push switch plunger 2430 is disposed such that one end thereof is contactable with the push switch shaft 2420 and the other end thereof is positioned on the push switch 2440 so as to depress the push switch 2440.

The push switch plunger 2430 includes a plunger body 2431 and a plunger stopper 2433. The plunger body 2431 is in contact with the push switch shaft base 2423, and the plunger stopper 2433 is formed to extend downwardly from the plunger body 2431 toward the push switch 2440. The plunger stopper 2433 restricts the movement distance of the plunger body 2431. In other words, a pressing force applied through the push switch knob 2410 and the push switch shaft 2420 is transferred to the push switch plunger 2430, which in turn is moved downwardly. At this time, the push switch plunger 2430 may be prevented from being excessively moved so as to avoid damage to the push switch 2440.

The push switch 2440 includes a push switch elastic part 2441, a push switch moving part 2443, and a push switch fixed part 2445.

The push switch elastic part 2441 may be configured of a rubber dome structure. The push switch elastic part 2441 includes a push switch elastic base part 24415, a push switch elastic support part 24113, and a push switch elastic moving part 24411.

The push switch moving part 2443 is disposed on the underside of the push switch elastic moving part 24411. The push switch fixed part 2445 is disposed on the rollover unit inner substrate 2210 of the rollover unit substrate 220 so as to be positioned at a position corresponding to the push switch moving part 2443.

In the meantime, in this embodiment, the push switch 2440 may be provided in plural numbers. In this case, the plural push switches 2440 are arranged at equal angular intervals on a plane perpendicular to the moving direction of the push switch shaft 2420. By virtue of such an arrangement, the moving operation of the push switch plunger 2430 may be stably supported.

In some case, the push switch 2440 may be selected in various manners, such as a configuration in which, when a predetermined movement play and a tilting operation are permitted, various switching signals may be generated in a tilting operation mode through signal combinations of the plurality of push switches 2440

Further, meanwhile, the rollover unit push switch part 240 of the sphere rollover unit 200 of the present invention may further include a push switch light source part 2460. The push switch light source part 2460 outputs light generated therefrom toward the push switch knob 2410. The structure of the push switch knob 2410 is the same as described above.

The sphere rollover unit 200 includes the rollover unit substrate 220. The rollover unit substrate 220 is disposed at least partially within the rollover unit housing 210.

The push switch light source part 2460 includes a push switch light source 2461 and a push switch light source transfer part 2463.

The push switch light source 2461 is disposed on one surface of the rollover unit substrate 220. The push switch light source transfer part 2463 is implemented as a rod type structure in this embodiment. The push switch light source transfer part 2463 is configured such that one end thereof confronts the push switch light source 2461 and the other end thereof is oriented toward the push switch knob 2410. The push switch light source transfer part 2463 transfers light emitted from the push switch light source 2461 to the push switch knob 2410.

Meanwhile, the sphere rollover switch device 10 includes a sphere rollover driving unit 300. The sphere rollover driving unit 300 is disposed in the device housing 100, and provides a driving force for enabling the up-and-down reverse rotation of the sphere rollover unit 200.

The sphere rollover driving unit 300 includes a rollover driving housing 310, a rollover driving actuator 330, and a rollover driving transfer gear part 320.

The rollover driving housing 310 is disposed to be fixed in position to the device housing 100. The rollover driving housing 310 includes a rollover driving housing body 311 and a rollover driving housing cover 313. The rollover driving housing body 311 and the rollover driving housing cover 313 are engaged with each other to define an internal space therebetween to allow other constituent elements to be accommodated therein.

The rollover driving housing body 311 has a through-hole 3111 formed on a side thereof so that a driving force generated from the rollover driving actuator 330 is transferred to the rollover unit body 2110 through the through-hole 3111.

The rollover driving actuator 330 is disposed within the rollover driving housing 310. The rollover driving actuator 330 is implemented as an electric motor. The rollover driving actuator 330 has an actuator shaft 331 disposed at an end thereof, and the actuator shaft 331 is meshingly engaged with the rollover driving transfer gear part 320.

The rollover driving transfer gear part 320 is meshingly engaged at one end with the rollover driving actuator 330 and at the other end with the rollover unit housing 210. The driving force generated from the rollover driving actuator 330 is transferred to the rollover unit housing 210.

The rollover driving transfer gear part 320 includes a first driving transfer gear 321, a second driving transfer gear 323, a third driving transfer gear 325, and a driving transfer spear gear 329. The third driving transfer gear 325 includes a driving transfer end gear 3251 formed at the inner side thereof. The driving transfer end gear 3251 is meshingly connected to the rollover unit shaft body 21120b. The driving transfer spear gear 329 is disposed on a side of the outer circumference of the rollover unit shaft body 21120b, and is engaged with the driving transfer end gear 3251 to transfer the driving force generated from the rollover driving actuator 330 to the rollover unit housing 210.

The driving force generated through the sphere rollover driving unit 300 allow the sphere rollover unit 200 to perform the up-and-down reverse rotation. The sphere rollover unit 200 of the present invention includes a rollover detection part 250 for more accurate rotation detection and compact configuration. The rollover detection part 250 is configured such that at least a part thereof is disposed at the rollover unit housing 210 and the remaining part thereof is disposed at the device housing 100.

The rollover detection part 250 is at least partially disposed on the rotary shaft for the up-and-down reverse rotation of the rollover unit housing 210.

More specifically, the rollover detection part 250 includes a rollover detection sensor 251 and a counterpart part 253 of the rollover detection sensor (hereinafter also referred to as a “rollover detection sensor counterpart part 253”).

The rollover detection sensor 251 is disposed within the rollover unit housing 210, and the rollover detection sensor counterpart part 253 is disposed on the rotary shaft of the rollover unit housing 210 so as to be fixed in position to the device housing 100. In other words, as the rollover unit housing 210 performs the up-and-down reverse rotation movement, the rollover detection sensor 251 also rotates along with the rollover unit housing 210, and the rollover detection sensor 251 detects an angular change resulting from its relative rotational movement with respect to the fixed rollover detection sensor counterpart part 253, which is positioned on the rotary shaft of the rollover unit housing 210.

More specifically, the rollover detection sensor counterpart part 253 is positioned on the housing support body 123. As described above, the rollover detection sensor counterpart part 253 is disposed at the side support hinge extension part 12323. The side support hinge extension part 12323 is disposed at the side support hinge 12321, which is formed on the housing vertical side body 1232 of the housing support body 123.

By virtue of such an axial arrangement of the rollover detection sensor counterpart part 253, the rotation movement may be detected more accurately. The rollover detection sensor counterpart part 253 is disposed on the side support hinge extension part 12323 so that the degree of freedom of the arrangement design of the rollover detection sensor 251 corresponding to the rollover detection sensor counterpart part 253 may be enhanced through a configuration in which the rollover detection sensor counterpart part 253 is introduced into the rollover unit housing 210.

More specifically, the rollover unit body 2110 includes the rollover unit main body 21110 and the rollover unit shaft body 21120 (21120a and 21120b) as described above. The rollover unit main body 21110 is reversibly rotated up and down. The rollover unit shaft bodies 21120a and 21120b are disposed at one ends on both sides of the rollover unit main body 21110 and connected at the other ends to the housing vertical side body 1232 and the housing vertical support body 1231 in a relatively rotatable manner.

In this case, the rollover unit shaft body extension receiving part 21121a is formed in the rollover unit shaft body 21120a, which is any one of the rollover unit shaft bodies 21120a and 21120b.

The side support hinge extension part 12323 is receivingly disposed in the rollover unit shaft body extension receiving part 21121a so that the rollover detection sensor 251 can be disposed to confront the rollover detection sensor counterpart part 253. By virtue of such a configuration, the relative rotation state of the rollover unit body 2110 may be detected more accurately even by a cheap two-dimensional magnetic sensor.

In this case, the rollover unit substrate 220 of the sphere rollover unit 200 includes the rollover unit inner substrate 2210 and the rollover unit connection substrate 2220, and the rollover unit inner substrate 2210 is disposed within the rollover unit housing 210.

The device substrate 400 is disposed within the device housing 100, and the sphere rollover unit 200 includes a rollover unit substrate 220. The rollover unit substrate 220 establishes an electrical connection with an external electrical device through the device substrate 400.

The device substrate 400 may include a substrate through-opening 401 formed therein to prevent interference between the rollover unit connection substrate 2220 and other constituent elements or mount the constituent elements, if necessary. The electrical connection between the device substrate 400 and the external electrical device may be established through a substrate connector 403 formed on the underside of the device substrate 400

The rollover unit substrate 220 includes the rollover unit inner substrate 2210 and the rollover unit connection substrate 2220. The rollover unit inner substrate 2210 is disposed within the rollover unit housing 210. The rollover unit connection substrate 2220 is connected at one end to the rollover unit inner substrate 2210 and at the other end to the device substrate 400.

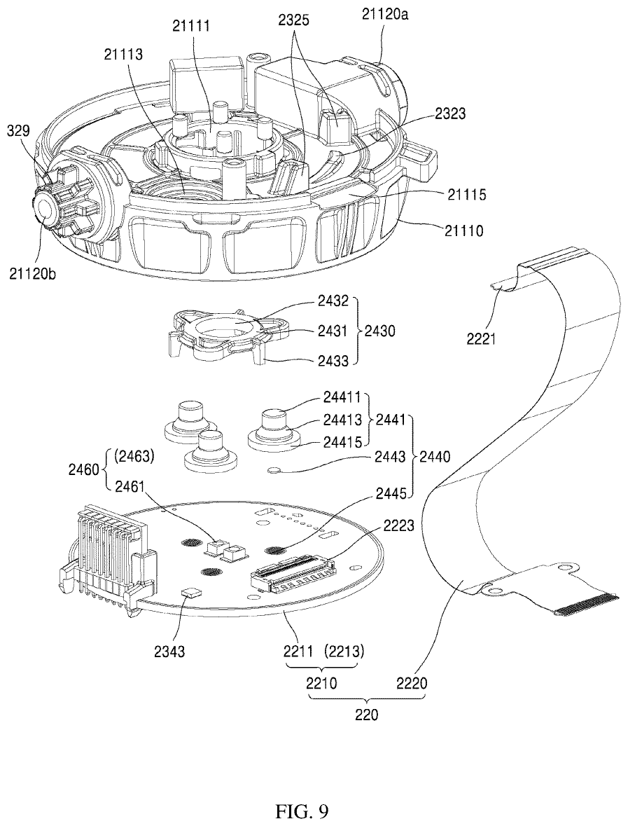

As shown in FIG. 9, a connection substrate connection part 2221 is disposed at an end of the rollover unit connection substrate 2220, and is connected to the rollover unit inner substrate 2210 positioned inside the rollover unit body 2110.

The rollover unit connection substrate 2220 is drawn out from the rollover unit housing 210 in a direction of an imaginary line drawn perpendicularly from the central point of the rotary shaft of the rollover unit housing 210. In the process in which the rollover unit connection substrate 2220 is withdrawn to the outside from the rollover unit body 2110, a configuration for preventing the rollover unit connection substrate 2220 from being bent will be replaced with the configuration as described previously.

In addition, the sphere rollover switch device 10 according to the present invention may further include a configuration for preventing noise or vibration that causes discomfort due to interference between elements. As described above, in a configuration in which the rollover unit substrate 220 is drawn out from the rollover unit housing 210 in a direction of an imaginary line drawn perpendicularly from the central point of the rotary shaft of the rollover unit housing 210, the sphere rollover switch device 10 may further include a configuration for preventing or minimizing contact noise or discomfort due to interference between the rollover unit connection substrate 2220 and other elements in the rapid winding/unwinding or flipping process of the rollover unit connection substrate 2220 during the up-and-down reverse rotation of the sphere rollover unit 200.

In other words, the sphere rollover switch device 10 according to another embodiment of the present invention includes a housing body flip space 126. As shown in FIG. 17, more specifically the housing body flip space 126 is formed in the housing body 120 of the device housing 100. The up-and-down reverse rotation of the rollover unit body 2110 enables the rollover unit connection substrate 2220 to be flipped within the housing body flip space 126.

In this case the housing body flip space 126 is defined by a housing body convex part 1261 and a housing body concave part 1263 of the housing body 120.

Herein, the housing body convex part 1261 is configured to be at least partially protruded toward the housing body flip space 126 of the housing body 120 from the outer surface thereof, and the housing body concave part 1263 is configured such that the inner surface of the housing body 120 is concaved so that the housing body flip space 126 of the housing body 120 can be further expanded.

That is, the housing h body convex part 1261 is configured to be at least partially protruded toward the housing body flip space 126 of the housing body 120 from the outer surface thereof.

In addition, when viewed from a plane perpendicular the rotary shaft of the sphere rollover unit 200, a profile radius from the center of the rotary shaft of the sphere rollover unit 200 to the inner surface of the housing body that defines the housing body flip space 126 may be measured. A profile radius (Rcvx) measured along the inner surface of the housing body convex part 1261 and a profile radius (Rccv) measured along the inner surface of the housing body concave part 1263 may be compared with each other. In this case, the profile radius has a maximum value (Rccv) at a point of the inner surface of the housing body concave part 1263.

Meanwhile, when one surface of interest of the sphere rollover unit 200 is disposed to be exposed to the outside and a point at which the rollover unit connection substrate 2220 is drawn out from the sphere rollover unit 200 is positioned adjacent to the housing body convex part 1261, the rollover unit connection substrate 2220 includes two flip regions (Wf1, Wf2).

In other words, when the rollover unit hemisphere 2120 on one surface of the sphere rollover unit 200 is disposed to be oriented toward the inside and the rollover unit rotary switch part 230 is disposed to be exposed to the outside, a point at which the rollover unit connection substrate 2220 is drawn out from the sphere rollover unit 200 is positioned more adjacent to the housing body convex part 1261 than the housing body concave part 1263 as shown in FIG. 17.

By virtue of such an arrangement, the rollover unit connection substrate 2220 is disposed so as to surround the outer circumference of the sphere rollover unit 200, and is configured such that the orientation of the rollover unit connection substrate 2220 is flipped at two regions indicated by reference numerals Wf1 and Wf2 in FIG. 17, including a point at which the rollover unit connection substrate 2220 is drawn out from the sphere rollover unit 200.

In this case, when the housing body flip space is divided into left and right regions based on the rotary shaft of the sphere rollover unit 200 on the drawing sheet of FIG. 17, a point at which the rollover unit connection substrate 2220 is connected to the device substrate 400 is positioned at a region where the housing body convex part 1261 is formed.

By virtue of such a configuration, a substantial portion of the rollover unit connection substrate 2220 required for tensioning forms a stable guide structure through contact with the outer circumferential surface of the housing body convex part 1261 during the flipping process in which the rollover unit connection substrate 2220 surrounds the sphere rollover unit 200, thereby minimizing unnecessary noise and preventing or minimizing discomfort to the user.

Further, contrary to the previous case, when one surface of interest of the sphere rollover unit 200 is disposed to be oriented toward the inside of the housing body 120, and a point at which the rollover unit connection substrate 2220 is drawn out from the sphere rollover unit 200 is positioned adjacent to the housing body concave part 1263, the rollover unit connection substrate 2220 may include one flip region (Wf3).

In other words, when the rollover unit hemisphere 2120 on one surface of the sphere rollover unit 200 is disposed to be oriented toward the outside and the rollover unit rotary switch part 230 is disposed to be oriented toward the inside, a point at which the rollover unit connection substrate 2220 is drawn out from the sphere rollover unit 200 is positioned more adjacent to the housing body concave part 1263 than the housing body convex part 1261 as shown in FIG. 19.

By virtue of such an arrangement, the rollover unit connection substrate 2220 is disposed so as to be spaced apart from the outer circumference of the sphere rollover unit 200 to form a predetermined tension state, and is configured such that the orientation of the rollover unit connection substrate 2220 is flipped at one region indicated by reference numerals Wf3 in FIG. 19, including a point at which the rollover unit connection substrate 2220 is drawn out from the sphere rollover unit 200.

In this case, when the housing body flip space is divided into left and right regions based on the rotary shaft of the sphere rollover unit 200 on the drawing sheet of FIG. 19, a point at which the rollover unit connection substrate 2220 is connected to the device substrate 400 is positioned at a region where the housing body concave part 1263 is formed.

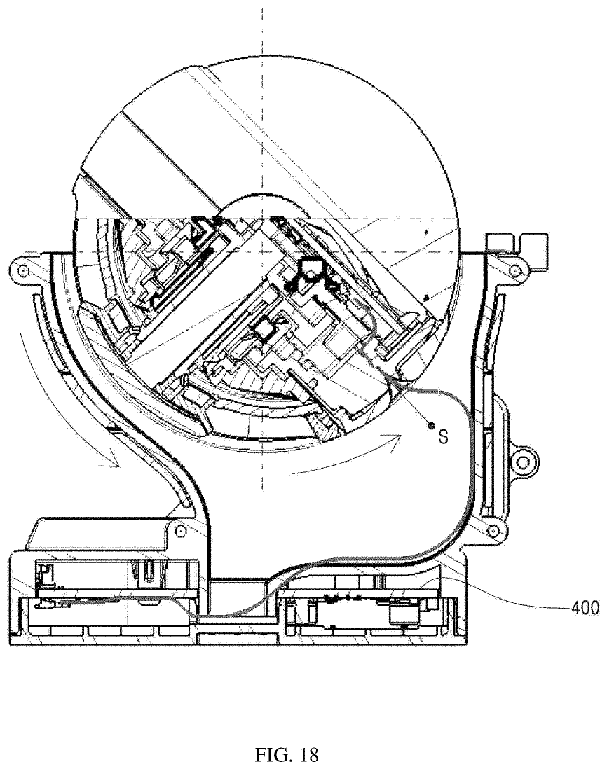

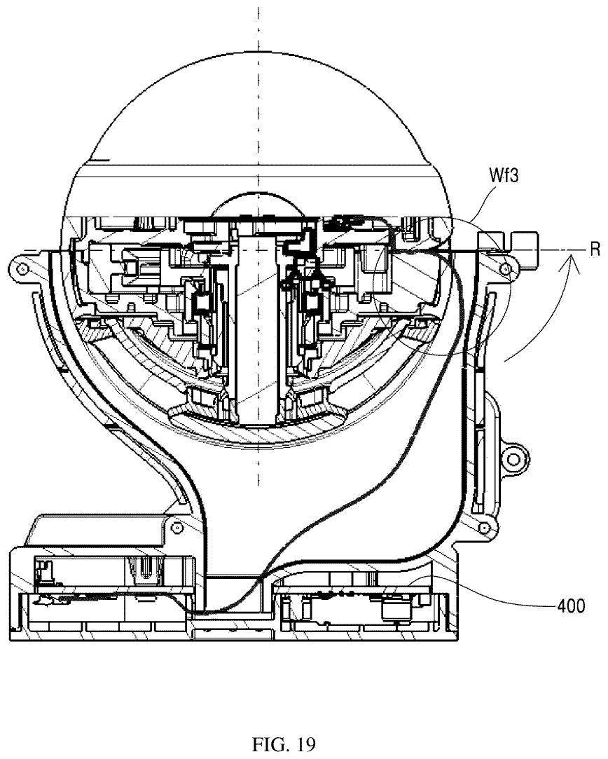

In other words, when the sphere rollover unit 200 is reversibly rotated up and down, contrary to the case of FIG. 17, a substantial portion of the rollover unit connection substrate 2220 is arranged to be spaced apart from the sphere rollover unit 200 and is guided in a relaxed state along the surface of the housing body concave part 1263 as shown in FIG. 18.

Even though the rollover unit connection substrate 2220 is implemented as an FPCB, it possesses a predetermined stiffness. Accordingly, the rollover unit connection substrate 2220 is disposed within an accommodation space of the housing body flip space 126, which is defined by the housing body concave part 1263, and is guided along the surface of the housing body concave part 1263.

Subsequently, as shown in FIG. 19, the rollover unit connection substrate 2220 forms a predetermined tensioned structure, and is configured such that its orientation is flipped at one region, indicated by reference numerals Wf3 in FIG. 19, as it is which is drawn out from the sphere rollover unit 200.

Through provision of the flipping space created by the housing body flip space and the guide process along the inner surface of the housing body that defines the housing body flip space, the rollover unit connection substrate 2220 forms a stable guide structure, thereby minimizing unnecessary noise and preventing or minimizing discomfort to the user.

The connection structure of the rollover unit connection substrate 2220 and the device substrate 400 may form a rear surface connection structure. In other words, as shown in FIGS. 4 and 17, the rollover unit connection substrate 2220 is electrically connected to a surface of the device substrate 400 opposite to the surface thereof that confronts the sphere rollover unit 200.

In this case, the device substrate 400 includes a substrate through-opening 401 formed therein, and the housing body 120 includes a housing body extension part 128 formed at a lower end thereof.

In addition, the housing body extension part 128 includes a housing body extension through-opening 129 formed therein. The housing body extension part 128 is disposed to pass through the substrate through-opening 401, and the rollover unit connection substrate 2220 is disposed to pass through the housing body extension through-opening 129.

By virtue of such a rear surface connection structure of the rollover unit connection substrate 2220 and the device substrate 400, the bending space of the rollover unit connection substrate 2220 is maximized, thereby ensuring a stable operation during the up-and-down reverse rotation of the sphere rollover unit 200 and preventing or minimizing unnecessary noise.

Further, the rollover unit inner substrate 2210 includes a unit inner substrate 2211 and a unit support substrate 2213. The switching elements of the rollover unit rotary switch part 230 and the rollover unit push switch part 240 may be disposed on the unit inner substrate 2211 as described above. The unit support substrate 2213 is disposed on one surface of the unit inner substrate 2211.

The unit support substrate 2213 is disposed adjacent to the inner side of the rollover unit shaft body extension receiving part 21121a formed at the rollover unit shaft body 21120a, and the rollover detection sensor 251 is disposed on one surface of the unit support substrate 2213. By virtue of such a configuration, the rollover detection sensor counterpart part 253 and the rollover detection sensor 251 are disposed to confront each other on the rotary shaft of the rollover unit body 2110.

In some cases, the rollover detection sensor counterpart part 253 and the rollover detection sensor 251 may be configured such that the rollover detection sensor 251 is disposed to be spaced apart from the rotary shaft of the rollover unit body 2110 without them confronting each other. That is, the rollover detection sensor 251 may be disposed to be spaced apart from the rotary shaft for the up-and-down reverse rotation of the rollover unit housing 210.

For example, the rollover detection sensor 251 may be implemented as a three-dimensional sensor disposed on the unit inner substrate 2211. In this case, the unit support substrate 2213 may be omitted. In addition, the rollover detection sensor counterpart part 253 may be positioned on the upper portion of the rollover detection sensor 251 through the extension of the side support hinge extension part 12323. Further, the rollover detection sensor 251 may detect he rotation of the rollover detection sensor counterpart part 253. In other words, the rollover detection sensor 251 is disposed on a line of the rotation axis of the rollover unit body 2110, but may be disposed to be spaced apart from the rotation axis of the rollover unit body 2110 in the radial direction of the rollover unit body 2110. The rollover detection sensor 251 may be directly disposed on one surface of the unit inner substrate 2211 so as to detect its relative rotation with respect to the rollover detection sensor counterpart part 253.

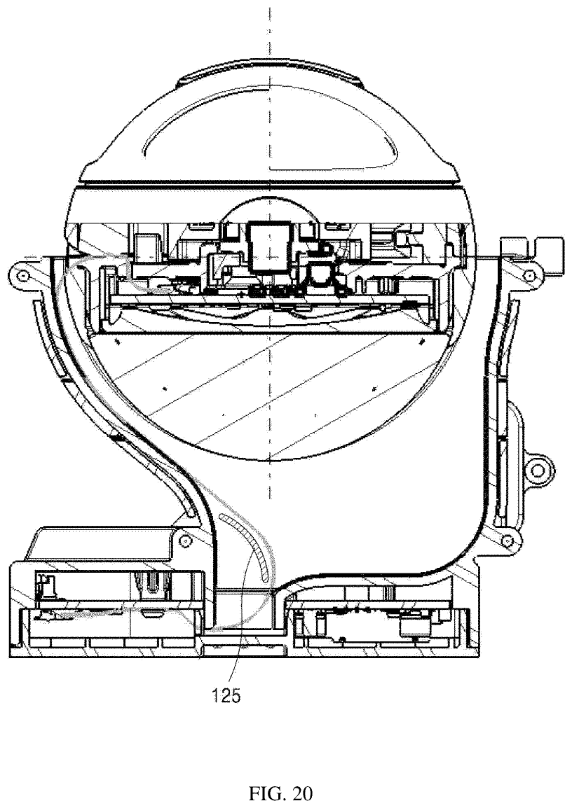

In the meantime, the housing body 120 of the device housing 100 may include a winding and unwinding guide for preventing twisting of the rollover unit connection substrate 2220. That is, as shown in FIG. 20, the housing body 120 may further include a housing connection guide 127 therein. The housing connection guide 127 is implemented as a curved structure in this embodiment, but may be modified in various forms, such as a configuration in which the housing connection guide in the form of a simple rib or pin is formed at multiple points. The housing connection guide 127 is configured to be contactable with the rollover unit connection substrate 2220 upon the up-and-down reverse rotation of the rollover unit body 2210. This configuration prevents the rollover unit connection substrate 2220 from being introduced into an unnecessary space. By virtue of this configuration, the rollover unit connection substrate 2220 is subjected to the winding or unwinding operation during the up-and-down reverse rotation of the sphere rollover unit 200. Accordingly, erroneous operation due to unnecessary action may be prevented during the unwinding operation.

By virtue of such a switching operation, the sphere rollover switch device 10 of the present embodiment may be implemented as a shift range switching device for selecting the shift range of a vehicle transmission. However, the present invention is not limited thereto, and may be implemented and applied as a switching device in various application fields.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the scope of protection of the present invention should be interpreted by the appended claims, and it should be interpreted that all technical spirits within the scope equivalent to the claims fall within the scope of the present invention.

### INDUSTRIAL APPLICABILITY

Although the present invention has been implemented focusing on a shift range switching device for selecting the shift range of a vehicle transmission, it may also be applied and utilized in various applications, such as being implemented as various switch devices for vehicles within the scope 44 performing the switching operation of a configuration that implements the rollover operation.

1. A sphere rollover switch device (10) comprising:
a device housing (100);
a sphere rollover unit (200) comprising a rollover unit housing (210) rotatably connected to the device housing (100) by means of a rotary shaft so as to perform an up-and-down reverse rotation, the sphere rollover unit being configured to perform a switching operation; and
a sphere rollover driving unit (300) disposed in the device housing (100), and configured to provide a driving force for enabling the up-and-down reverse rotation of the sphere rollover unit (200),
wherein the sphere rollover unit (200) comprises a rollover detection part (250) configured such that at least a part thereof is disposed at the rollover unit housing (210) and the remaining part thereof is disposed at the device housing (100).

2. The sphere rollover switch device (10) according to claim 1, wherein the rollover detection part (250) is at least partially disposed on a rotary shaft for the up-and-down reverse rotation of the rollover unit housing (210),
wherein the rollover detection part (250) comprises a rollover detection sensor (251) and a rollover detection sensor counterpart part (253), and
wherein the rollover detection sensor counterpart part (253) is disposed on the rotary shaft of the rollover unit housing (210) so as to be fixed in position to the device housing (100).

3. The sphere rollover switch device (10) according to claim 2, wherein the device housing comprises a housing body (120) configured to support the rotation of the rollover unit housing (210),
wherein the housing body (120) comprises:
a housing bottom body (121) mounted so as to be securely fixed in position; and
a housing support body (123) formed extending upwardly from one surface of the housing bottom body (121), and
wherein the rollover detection sensor counterpart part (253) is disposed at the housing support body (123).

4. The sphere rollover switch device (10) according to claim 3, wherein the housing support body (123) comprises:
a housing vertical support body (1231) connected at one end to the housing bottom body (121); and
a housing vertical side body (1232) connected at one end to a side end of the housing vertical support body (1231) to allow the rollover unit housing (210) to be rotatably mounted, and
wherein the rollover unit housing (210) comprises:
a rollover unit body (2110) disposed at both ends at the housing support body (123) in a relatively movable manner; and
a rollover unit bearing (2130) disposed between the rollover unit body (2110) and the housing support body (123).

5. The sphere rollover switch device (10) according to claim 4, wherein the housing vertical side body (1232) comprises a side support hinge (12321) on at least one side thereof, the side support hinge (12321) being connected to the rollover unit housing (210) so as to be relatively rotatable with respect to the rollover unit housing (210),
wherein the side support hinge (12321) comprises a side support hinge extension part (12323) disposed to extend toward the rollover unit housing (210), and
wherein the rollover detection sensor counterpart part (253) is disposed at the side support hinge extension part (12323).

6. The sphere rollover switch device (10) according to claim 5, wherein the rollover unit body (2110) comprises:
a rollover unit main body (21110) configured to be reversibly rotated up and down; and
a pair of opposed rollover unit shaft bodies (21120; 21120a and 21120b) disposed at one ends on both sides of the rollover unit main body (21110) and connected at the other ends to the housing vertical side body (1232) and the housing vertical support body (1231) in a relatively rotatable manner.

7. The sphere rollover switch device (10) according to claim 6, wherein a rollover unit shaft body extension receiving part (21121a) is formed in any one of the rollover unit shaft bodies (21120a and 21120b), and
wherein the side support hinge extension part (12323) is receivingly disposed in the rollover unit shaft body extension receiving part (21121a).

8. The sphere rollover switch device (10) according to claim 7, wherein the rollover detection sensor (251) is disposed to confront the rollover detection sensor counterpart part (253).

9. (canceled)

10. The sphere rollover switch device (10) according to claim 7, wherein a shaft body driving counterpart part (21121b) is disposed at any one of the rollover unit shaft bodies (21120a and 21120b), and
wherein the sphere rollover driving unit (300) is at least partially disposed at the shaft body driving counterpart part (21121b) to allow the shaft body driving counterpart part (21121b) to be applied with the driving force from a rollover driving actuator (330) of the sphere rollover driving unit (300).

11. (canceled)

12. (canceled)

13. The sphere rollover switch device (10) according to claim 1, further comprising a device substrate (400) disposed within the device housing (100),
wherein the sphere rollover unit (200) comprises a rollover unit substrate (220), and
wherein the rollover unit substrate (220) comprises:
a rollover unit inner substrate (2210) disposed within the rollover unit housing (210); and
a rollover unit connection substrate (2220) connected at one end to the rollover unit inner substrate (2210) and at the other end to the device substrate (400).

14. The sphere rollover switch device (10) according to claim 13, wherein the rollover unit substrate (220) is drawn out from the rollover unit housing (210) in a direction of an imaginary line drawn perpendicularly from the central point of the rotary shaft of the rollover unit housing (210).

15. The sphere rollover switch device (10) according to claim 14, wherein the housing body (120) of the device housing (100) comprises a housing body flip space (126) formed therein, and
wherein the up-and-down reverse rotation of the rollover unit body (2110) enables the rollover unit connection substrate (2220) to be flipped within the housing body flip space (126).

16. The sphere rollover switch device (10) according to claim 15, wherein the housing body flip space (126) is defined by a housing body convex part (1261) and a housing body concave part 1263 of the housing body (120),
wherein the housing body convex part (1261) is formed to be at least partially protruded toward the housing body flip space (126) of the housing body (120) from the outer surface thereof, and
wherein when viewed from a plane perpendicular the rotary shaft of the sphere rollover unit (200), a position, which has a maximum value of a profile radius from the center of the rotary shaft of the sphere rollover unit (200) to the inner surface of the housing body that defines the housing body flip space (126), is formed on the housing body concave part (1263).

17. The sphere rollover switch device (10) according to claim 16, wherein when a surface of interest of the sphere rollover unit (200) is disposed to be exposed to the outside, and a point at which the rollover unit connection substrate (2220) is drawn out from the sphere rollover unit (200) is positioned adjacent to the housing body convex part (1261), the rollover unit connection substrate (2220) includes two flip regions (Wf1, Wf2).

18. The sphere rollover switch device (10) according to claim 16, wherein when a surface of interest of the sphere rollover unit (200) is disposed to be oriented toward the inside of the housing body (120), and a point at which the rollover unit connection substrate (2220) is drawn out from the sphere rollover unit (200) is positioned adjacent to the housing body concave part (1263), the rollover unit connection substrate (2220) includes one flip region (Wf3).

19. The sphere rollover switch device (10) according to claim 15, wherein the rollover unit connection substrate (2220) is electrically connected to a surface of the device substrate (400) opposite to the surface thereof that confronts the sphere rollover unit (200).

20. The sphere rollover switch device (10) according to claim 19, wherein the device substrate (400) includes a substrate through-opening (401) formed therein,
wherein the housing body (120) includes a housing body extension part (128) formed at a lower end thereof,
wherein the housing body extension part (128) includes a housing body extension through-opening (129) formed therein,
wherein the housing body extension part (128) is disposed to pass through the substrate through-opening (401), and
wherein the rollover unit connection substrate (2220) is disposed to pass through the housing body extension through-opening (129).

21. The sphere rollover switch device (10) according to claim 14, wherein the rollover unit body (2110) of the rollover unit housing (210) comprises a rollover unit outer body (21140) disposed at the outer side thereof, and
wherein the rollover unit outer body (21140) comprises an outer body connection withdrawal opening (21145) formed on the outer circumferential edge thereof to allow the rollover unit connection substrate (2220) to be withdrawn therethrough.

22. The sphere rollover switch device (10) according to claim 21, wherein the rollover unit outer body (21140) comprises an outer body chamfering connection guide (21147) formed on the outer periphery of the outer body connection withdrawal opening (21145) thereof, and
wherein the outer body chamfering connection guide (21147) guides the rollover unit connection substrate (2220) during the up-and-down reverse rotation of the rollover unit body (2110).

23. The sphere rollover switch device (10) according to claim 22, wherein the device housing (100) comprises a housing connection guide (127) formed therein so as to be contactable with the rollover unit connection substrate (2220) upon the up-and-down reverse rotation of the rollover unit body (2210).
